(19) United States
(12) Patent Application Publication
(10) Pub. No.: US 2018/0266739 A1
(43) Pub. Date: Sep. 20, 2018

(54) SYSTEMS AND METHODS FOR PROVIDING A PHASE CHANGE MATERIAL PANEL AND CHARGING UNIT FOR COOLING A CABINET OF A MERCHANDISER

(71) Applicant: The Coca-Cola Company, Atlanta, GA (US)

(72) Inventor: Vinayak Godbole, Peachtree city, GA (US)

(21) Appl. No.: 15/781,539

(22) PCT Filed: Nov. 4, 2016
(86) PCT No.: PCT/US2016/060546

§ 371 Date: Jun. 5, 2018

Related U.S. Application Data
(60) Provisional application No. 62/266,033, filed on Dec. 11, 2015.

(51) Int. Cl. F25B 39/02; F25D 11/00; F28D 1/047; F28D 20/02; F28F 1/12; F28F 3/12; G07F 9/10

(52) U.S. Cl. CPC F25B 39/02; F25D 11/006; F28D 1/047; F28D 2020/0013; F28F 1/12; F28F 3/12; G07F 9/10; F28D 20/021

(57) ABSTRACT

A phase change material panel for cooling a cabinet of a merchandiser is disclosed. The panel may include a refrigerant tube, an outer jacket surrounding the refrigerant tube, and a phase change material positioned between the refrigerant tube and the outer jacket and in contact with the refrigerant tube.

### CROSS-REFERENCE TO RELATED APPLICATIONS

The disclosure claims priority to and the benefit of U.S. provisional application No. 62/266,033, filed Dec. 11, 2015, which is herein incorporated by reference in its entirety.

### FIELD OF THE DISCLOSURE

The disclosure generally relates to merchandisers and more particularly relates to a phase change material panel and charging unit for cooling a cabinet of a merchandiser.

### BACKGROUND

Typical cold beverage merchandisers, such as coolers, vending machines, etc., include built-in refrigeration systems. These refrigeration systems include electro-mechanical components that move a refrigerant through a refrigeration cycle to remove heat from a cabinet of the merchandiser. Such systems need continuous or near continuous external power to operate. In certain developing parts of the world, the availability of electrical power is not continuous or may be non-existent at the point-of-sale. This is an impediment to serving cold beverages in such locations.

### SUMMARY

Some or all of the above needs and/or problems may be addressed by certain embodiments of the disclosure. For example, according to an embodiment, a phase change material panel for cooling a cabinet of a merchandiser is disclosed. The panel may include a refrigerant tube, an outer jacket surrounding the refrigerant tube, and a phase change material positioned between the refrigerant tube and the outer jacket and in contact with the refrigerant tube.

Other features and aspects of the disclosure will be apparent or will become apparent to one with skill in the art upon examination of the following figures and the detailed description. All other features and aspects, as well as other system, method, and assembly embodiments, are intended to be included within the description and are intended to be within the scope of the accompanying claims.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 schematically depicts a merchandiser with a panel therein in accordance with one or more embodiments of the disclosure.

FIG. 2 schematically depicts a panel in accordance with one or more embodiments of the disclosure.

FIG. 3 schematically depicts a side view of a panel in accordance with one or more embodiments of the disclosure.

FIG. 4 schematically depicts a panel in accordance with one or more embodiments of the disclosure.

FIG. 5 schematically depicts a panel and charging unit in accordance with one or more embodiments of the disclosure.

FIG. 6 schematically depicts a panel in accordance with one or more embodiments of the disclosure.

FIG. 7 schematically depicts a panel in accordance with one or more embodiments of the disclosure.

FIG. 8 schematically depicts a panel in accordance with one or more embodiments of the disclosure.

FIG. 9 schematically depicts a panel in accordance with one or more embodiments of the disclosure.

FIG. 10 schematically depicts a panel in accordance with one or more embodiments of the disclosure.

FIG. 11 schematically depicts a panel in accordance with one or more embodiments of the disclosure.

FIG. 12 schematically depicts a panel in accordance with one or more embodiments of the disclosure.

FIG. 13 schematically depicts a panel in accordance with one or more embodiments of the disclosure.

FIG. 14 schematically depicts a panel in accordance with one or more embodiments of the disclosure.

### DETAILED DESCRIPTION

Described below are embodiments of systems and methods for providing a phase change material panel and charging unit for cooling a cabinet of a merchandiser (as well as individual components of the panel and charging unit). Methods of manufacturing and using the panel and charging unit are also disclosed.

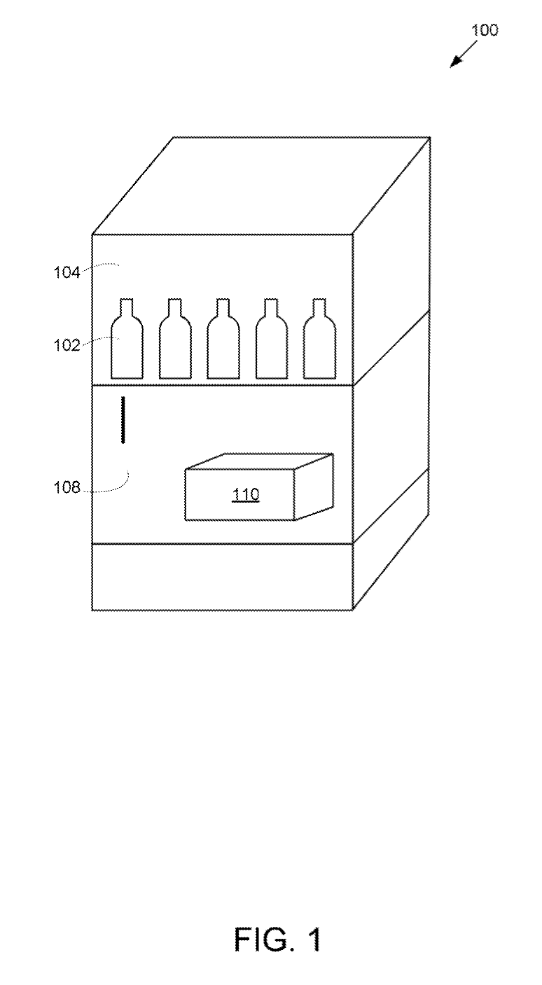

FIG. 1 depicts a merchandiser 100. Generally speaking, the merchandiser 100, which may also be referred to as a cold beverage merchandiser, a beverage dispenser, a vending machine, or a cooler, may be configured to dispense or otherwise enable access to one or more products 102, such as beverage containers or the like. For example, the merchandiser 100 may include a cabinet 104 in which the one or more products 102 are housed. In some instances, a user (e.g., a consumer) may access the one or more products 102 within the cabinet 104 of the merchandiser 100 by way of an access port or door 108. The size, shape, and configuration of the merchandiser 100 may vary. Although the disclosure has been described with reference to beverages, other items may be stored within the cabinet 104 of the merchandiser 100, including perishable items, edible products, promotional items, or the like. Any item or product where a temperature controlled setting is desirable may be stored within the cabinet 104 of the merchandiser 100.

In order to cool the cabinet 104 of the merchandiser 100, a phase change material panel 110 may be disposed within the cabinet 104 of the merchandiser. In some instances, the panel 110 may be disposed within another compartment of the merchandiser 100 that is in thermal communication with the cabinet 104. The panel 110 may be disposed at any location within the merchandiser 100. In some instances, the panel 110 may removably form one of the walls of the cabinet 104. For example, the back panel of the cabinet 104 or a portion thereof may be formed by the panel 110, which may be removably affixed to the cabinet 104. Other walls of the cabinet 104 may be formed by the panel 110, such as the top, either side wall, or bottom. In some instances, the cabinet 104 may be formed by more than one of the panel 110. The panel 110 may be rectangular, triangular, circular, or the like. The panel 110 may be any size, shape, or configuration.

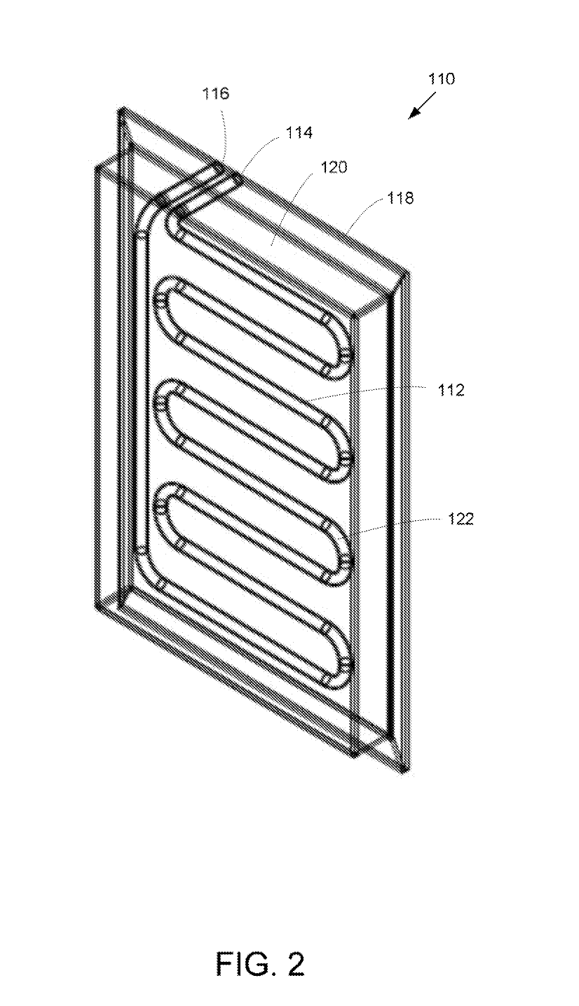

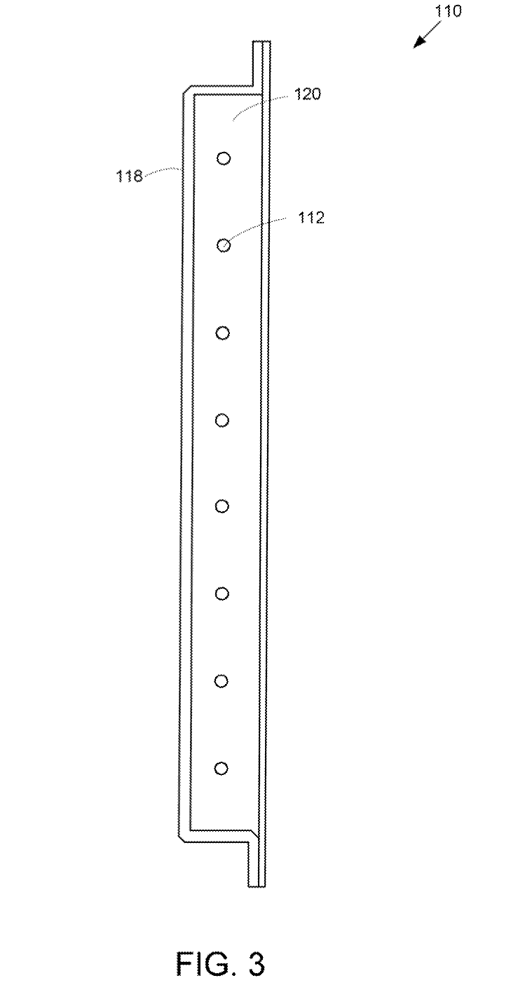

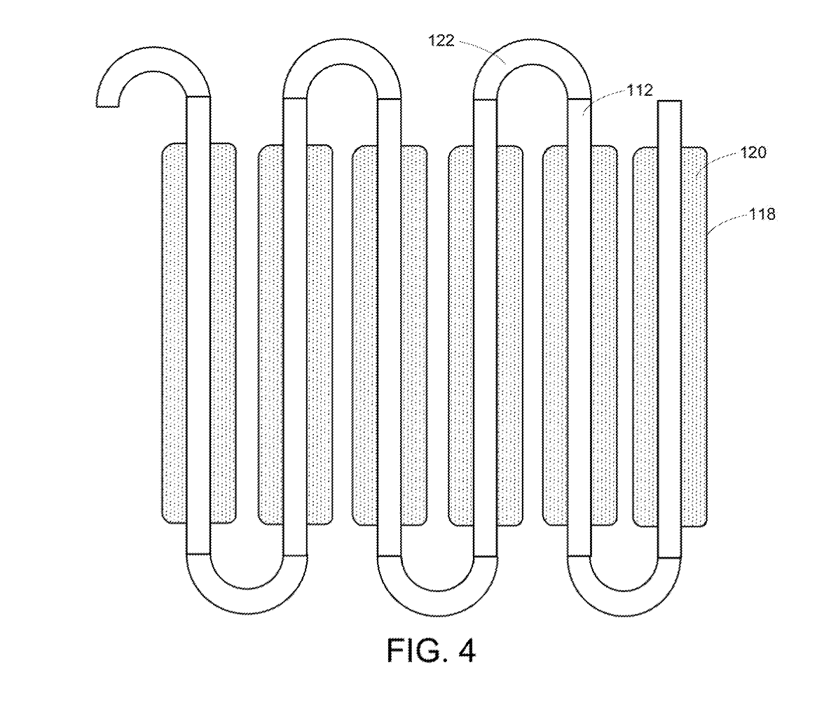

As depicted in FIGS. 2-4, the panel 110 may include a refrigerant tube 112 having an inlet 114 and an outlet 116. Any number of refrigerant tubes 112 may be used. The refrigerant tube 112 may be made out of any suitable type of substantially rigid material, such as various types of thin metals with good heat exchange properties. The refrigerant tube 112 may have any suitable size, shape, or configuration. The panel 110 also may include an outer jacket 118 surrounding the refrigerant tube 112. The outer jacket 118 may form an outer shell of the panel 110. The outer jacket 118 may be made out of any suitable type of substantially rigid material, such as various types of thin metals with good heat exchange properties. In some instances, the outer jacket 118 may be made out of multiple materials, such as an insulating material (e.g., foam filled plastic) for the exterior surface of the outer jacket 118 and a thermally conducting material (e.g., a thin metal) for the interior surface of the outer jacket 118. The exterior surface of the outer jacket 118 may be the surface of the panel 110 that is exposed to or otherwise subject to ambient conditions. The interior surface of the outer jacket 118 may be the surface of the panel that is exposed to the interior of the cabinet 104 for heat exchange therewith. The outer jacket 118 may have any suitable size, shape, or configuration.

A phase change material 120 may be positioned within the outer jacket 118. For example, the phase change material 120 may be positioned between the refrigerant tube 112 and the outer jacket 118. In some instances, the refrigerant tube 112 may be wholly or partially embedded within the phase change material 120. The phase change material 120 may be in contact with the refrigerant tube 112 and/or the outer jacket 118. The phase change material 120 may be any type of two phase (solid/liquid) material. The phase change material 120 may include different kinds and blends of waxes and the like with a freezing point at, above, or below the freezing point of water. The phase change material 120 may be natural and/or petroleum derived. Suitable examples may include paraffin wax, lauric acid, sodium silicate, coconut oil, water, water and alcohol, water and salts, a glycol solution, a brine solution, and the like. Other types of phase change materials may be used herein. The melting and freezing temperatures of the phase change material may vary. Phase change materials with differing melting and solidification temperatures may be used herein.

In some instances, the refrigerant tube 112 may include a number of bends 122. Any number of bends 122 may be used. In addition, as discussed below, the refrigerant tube 112 may include a number of fins extending into the phase change material 120. Any number of the refrigerant tube fins may be used herein in any suitable size, shape, or configuration. In some instances, as discussed below, the outer jacket 118 also may include a number of fins extending outward into the interior space of the cabinet 104. Any number of the outer jacket fins may be used in any suitable size, shape, or configuration. The outer jacket fins may further assist in heat transfer with the interior space of the cabinet 104. Other components and other configurations may be used herein.

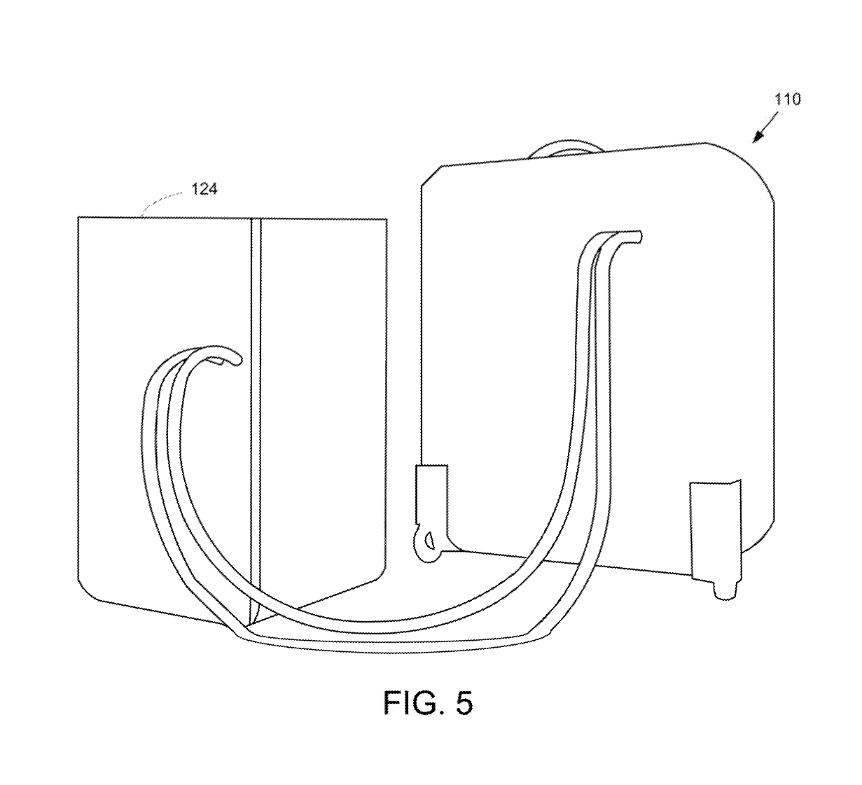

Before placing the panel 110 within or attaching the panel 110 to the cabinet 104 of the merchandiser 100, the phase change material 120 may be frozen (or solidified). For example, as depicted in FIG. 5, the panel 110 may be attached to a charging unit 124. That is, the charging unit 124 may be attached to the inlet 114 and the outlet 116 of the refrigerant tube 112. The charging unit 124 may comprise a container/reservoir of cold fluid. In some instances, the cold fluid may comprise a refrigerant. The cold fluid may be circulated in the panel 110. In some instances, the charging unit 124 may be a portable cooler such as a powered Glycol chiller, which can make cold fluid in a close loop. In this manner, a flow of cooling fluid (e.g., refrigerant or the like) may flow through the refrigerant tube 112 from the inlet 114 to the outlet 116. For example, the flow of cooling fluid may flow from the charging unit 124, into the inlet 114 of the refrigerant tube 112, and out of the outlet 116 of the refrigerant tube 112 back to the charging unit 124. The flow of cooling fluid may freeze or solidify the phase change material 120. In some instances, it may take several minutes, hours, or days to freeze or solidify the phase change material 120 (i.e. charge the panel 110). The charging time may vary depending on the size, shape, configuration, and chemical makeup of the panel 110 and/or charging unit 124. Any suitable cooling fluid may be used. For example, the cooling fluid may include glycol or the like.

The panel 110 may be charged at or near the point-of-sale or remotely therefrom, such as at a warehouse, on a trucks, at a distribution center, or the like and brought to the merchandiser 100. In some instances, the panel 110 may be removed from the merchandiser 100 and charged at a warehouse or elsewhere. In other instances, the charging unit 124 maybe brought to the point-of-sale or nearby for charging the panel 110. The panel 110 and/or charging unit 124 may include a handle and/or wheels to facilitate moving the panel 110 and/or charging unit 124. The panel 110 may be charged and recharged numerous times. In this manner, the panel 110 may be reusable.

After the phase change material 120 has been frozen, the charging unit 124 may be disconnected, and the panel 110 may be placed within the cabinet 104 of the merchandiser 100. Upon disconnecting the panel 110 from the charging unit 124, the refrigerant tube 112 inlet and outlet may be plugged. Any number of panels 110 may be used. The phase change material 120 may remove heat from the cabinet 104 of the merchandiser 100 by drawings heat from the interior space of the cabinet as the phase change material 120 melts or liquefies. After the phase change material 120 has melted, the panel 110 may be removed from the cabinet 104 of the merchandiser 100 and the process may be repeated. For example, the depleted panels 110 may be swapped out with other charged panels 110 as needed. In this manner, the panels 110 are removable and replaceable. In some instances, the panel 110 may be charged within the cabinet 104 of the merchandiser 100. In such instances, the panel 110 may not be removed from the cabinet 104 of the merchandiser 100.

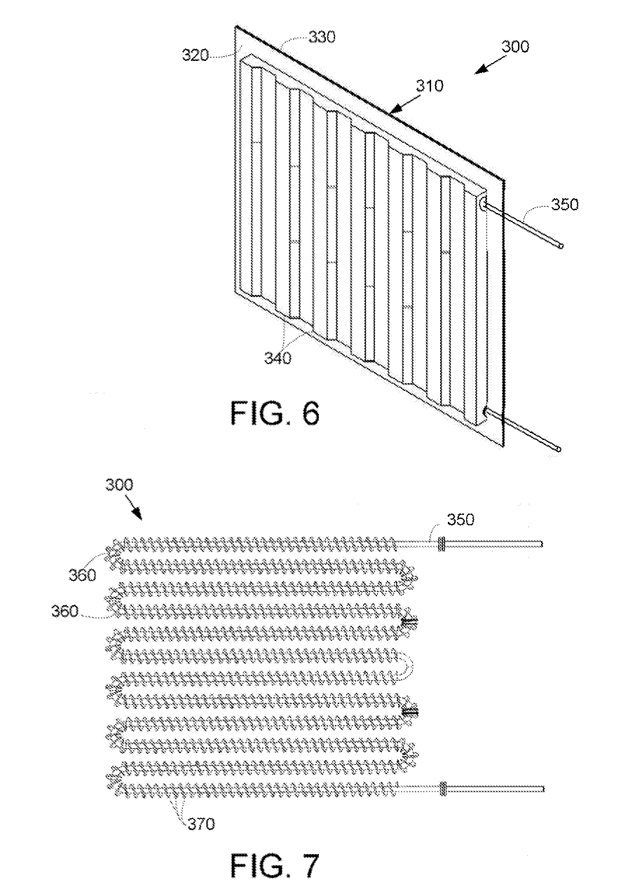

FIGS. 6-8 show a further embodiment of a panel 300. The panel 300 may be disposed within the cabinet 104 of the merchandiser 100. The panel 300 may include an outer jacket 310. The outer jacket 310 may include a first half 320 and a second half 330. As is shown in FIG. 6, the halves 320, 330 may have a corrugated pattern 340 thereon with a repeating series of raised and lowered portions for an increase in surface area and hence an increase in heat transfer between the phase change material 120 therein and the air within the cabinet 104. Other types of surface patterns may be used herein. The outer jacket 310 and the halves 320, 330 thereof may have any suitable size, shape, or configuration. The halves 320, 330 may be welded or otherwise joined together. The outer jacket 310 may be formed in a roll stamping or an extrusion process or other types of manufacturing processes. Other components and other configurations may be used herein.

The panel 300 also may include one or more refrigerant tubes 350 extending therethrough. In this example, a single refrigerant tube 350 may be used. The refrigerant tube 350 may have any suitable size, shape, or configuration. As is shown in FIG. 7, the refrigerant tube 350 may have a number of bends 360 therein. The number and the nature of the bends 360 may vary. The refrigerant tube 350 may have a number of fins 370 positioned thereon. In this example, the fins 370 may be a continuous fin that corkscrews around the refrigerant tube 350. Other types of fin designs may be used herein. For example, a number of discontinuous or continuous fins may be used. Likewise, horizontally or vertically running fins also may be used herein. Any number of the fins 370 may be used herein in any suitable size, shape, or configuration. Combinations of different type of fins 370 also may be used herein. The fins 370 provide an increase in surface area and hence an increase in heat transfer between the refrigerant 120, the refrigerant tube 350, and the phase change material 120. Other components and other configuration may be used herein.

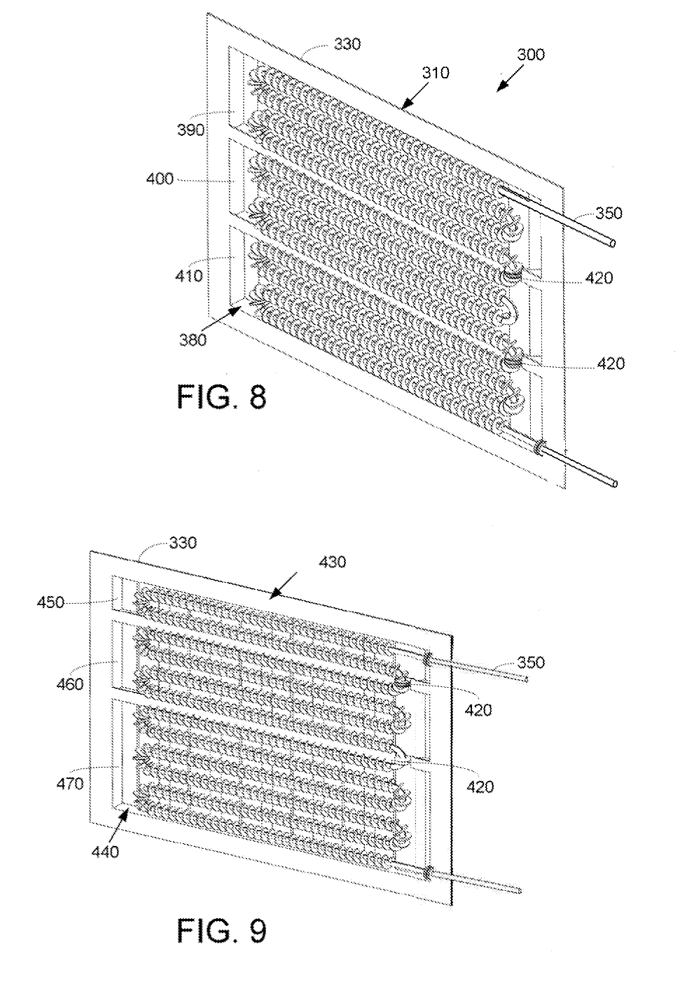

FIG. 8 shows the refrigerant tube 350 positioned within one of the halves 320, 330 of the outer jacket 310. In this example, the outer jacket 310 may be divided into a number of uniform compartments 380. Specifically, a first compartment 390, a second compartment 400, and a third compartment 410. Any number of compartments 380 may be used herein in any suitable size, shape, or configuration. A washer 420 or a similar type of barrier may be positioned about the refrigerant tube 350 between the compartments 380. The phase change material 120 thus may fill each of the compartments 380 for heat exchange therewith. The compartments 380 may have a phase change material 120 therein with differing melting and solidification temperatures for further increases in efficiency. The panel 300 promotes heat exchange between the refrigerant and the refrigerant tube 350; between the refrigerant tube 350 and the phase change material 120; between the phase change material 120 and the outer jacket 310; and between the outer jacket 310 and the air within the cabinet 104. Other components and other configurations may be used herein.

FIG. 9 shows an alternative embodiment of an outer jacket 430. In this example, the outer jacket 430 may include a number of varying volume compartments 440. Specifically, a first compartment 450, a second compartment 460, and a third compartment 470. As is shown, the second compartment 460 may be larger than the first compartment 450 and the third compartment 470 may be larger than the second compartment 460. Any number of the varying volume compartments 440 may be used herein in any suitable size, shape, or configuration. Other components and other configurations may be used herein. Moreover, the varying volume compartments 440 may have a phase change material 120 therein with differing melting and solidification temperatures for further increases in efficiency.

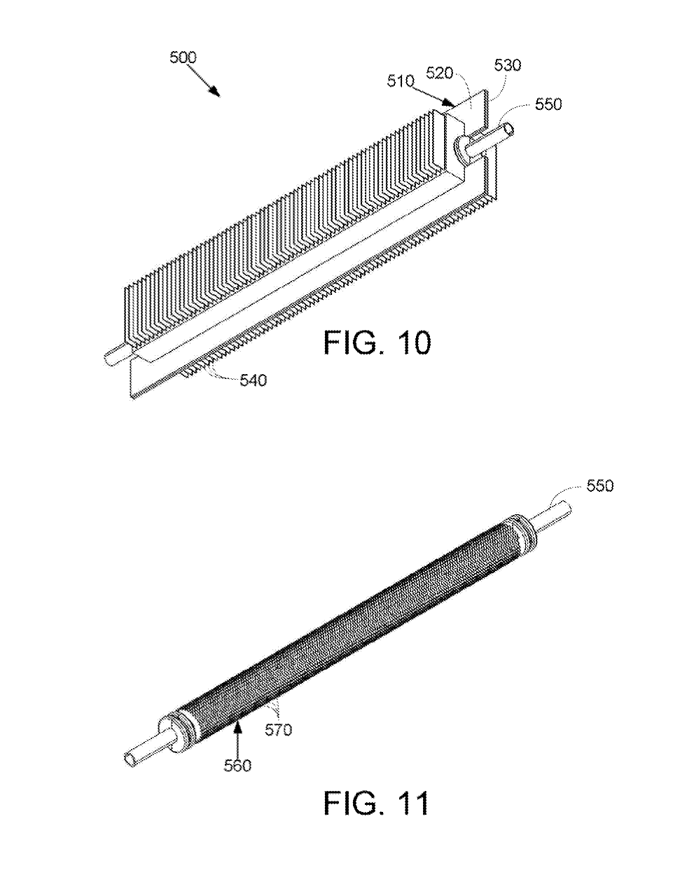

FIGS. 10-12 show a further embodiment of a panel 500 as may be described herein. In this example, the panel 500 may include an outer jacket 510. The outer jacket 510 may include a first half 520 and a second half 530. As is shown in FIG. 10, the halves 520, 530 of the outer jacket 510 may have any number of outer jacket fins 540. The outer jacket fins 540 may extend from the halves 520, 530 into the air within the cabinet 104. Although a number of vertically extending, horizontally separate fins 540 are shown, other types of fin designs may be used herein. For example, a number of discontinuous or continuous fins may be used. Likewise, horizontally or vertically running fins also may be used herein. Any number of the fins 540 may be used herein in any suitable size, shape, or configuration. Combinations of different type of fins 540 also may be used herein. Further, the fins 540 may extend inside as well as outside the outer jacket 510. The fins 540 provide an increase in surface area and hence an increase in heat transfer between the outer jacket 510 and the air in the cabinet 104. Other components and other configurations also may be used herein.

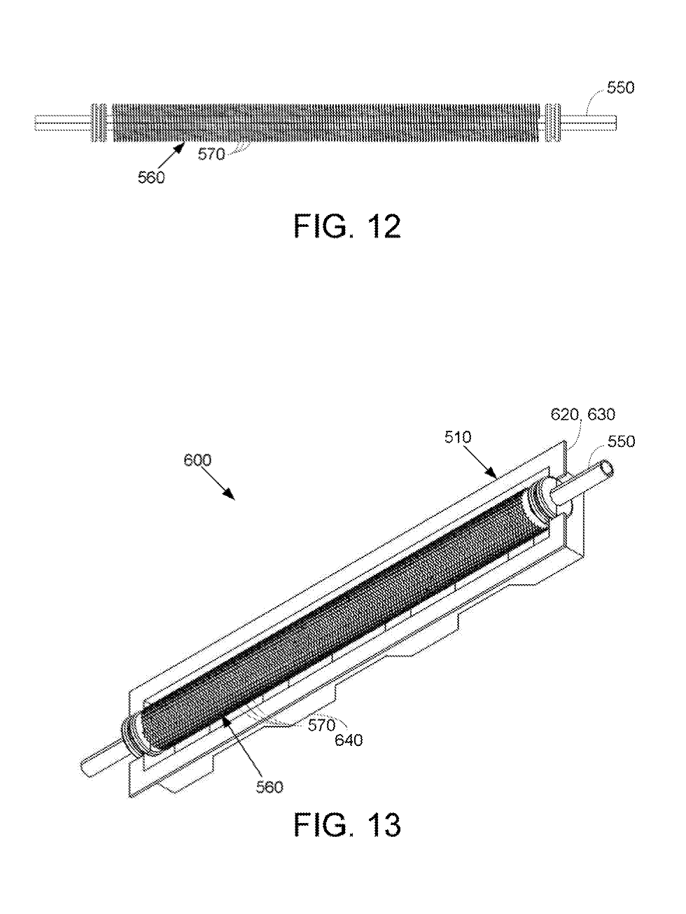

The panel 500 also may include one or more refrigerant tubes 550 extending therethrough. The refrigerant tube 550 may be straight or bent or otherwise configured. In this example, the refrigerant tube 550 may include a number of fins 560 thereon. As is shown in FIGS. 11 and 12, the fins 560 may be a number of star shaped fins 570. The star shaped fins 570 may be a continuous fin that corkscrews around the refrigerant tube 550. Other types of fin designs may be used herein. For example, a number of discontinuous or continuous fins may be used. Likewise, horizontally or vertically running fins also may be used herein. Any number of the fins 570 may be used herein in any suitable size, shape, or configuration. Combinations of different type of fins 570 also may be used herein. The fins 570 provide an increase in surface area and hence an increase in heat transfer between the refrigerant 120, the refrigerant tube 550, and the phase change material 120. Other components and other configurations may be used herein.

FIG. 13 shows a further embodiment of a panel 600 as may be described herein. The panel 600 may include an outer jacket 610. The outer jacket 610 may include a first half 620 and a second half 630. In this example, the halves 620, 630 may have a corrugated pattern 640 thereon with a repeating series of raised and lowered portions for an increase in surface area and hence an increase in heat transfer between the phase change material 120 and the air in the cabinet 104. Other types of surface patterns may be used herein. The outer jacket 610 may have any suitable size, shape, or configuration. The refrigerant tube 550 with the star shaped fins 570 may be positioned within the outer jacket 610 for heat exchange therewith. Other components and other configurations also may be used herein.

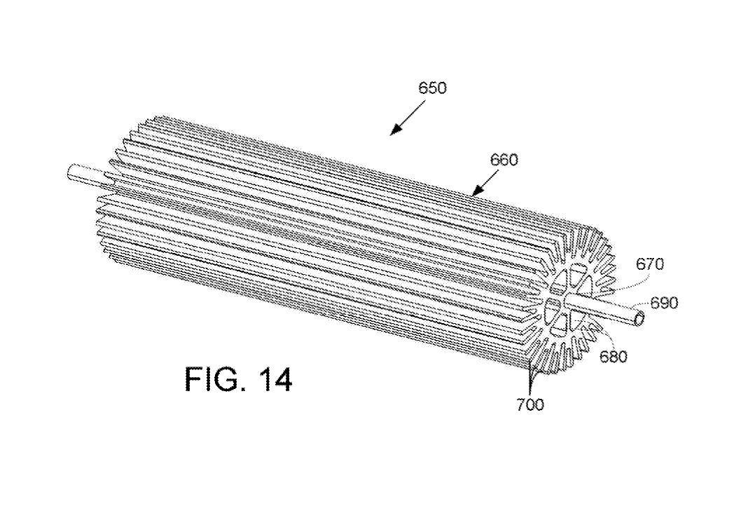

FIG. 14 shows a further embodiment of a panel 650 as may be described herein. The panel 650 may include an outer jacket 660. The outer jacket 660 may include a central bore 670 and a number of cavities 680. In some instances, the cavities 680 may form a circumferential array about the central bore 670. A refrigerant tube 690 may extend through the central bore 670. The cavities 680 may extend along the length of the outer jacket 660 in whole or in part. The phase change material 120 may fill each of the cavities 680. Differing phase change materials may be used in some or all of the cavities 680. An end cap (not shown) and the like may enclose the cavities. The outer jacket 660 and the cavities 680 may have any suitable size, shape, or configuration. The outer jacket 660 may be made in an extrusion process and the like.

The outer jacket 660 may have a number of star shaped fins 700. The star shaped fins 700 may extend radially therefrom. Other types of fin designs may be used herein. For example, a number of discontinuous or continuous fins may be used. Likewise, horizontally or vertically running fins also may be used herein. Any number of the fins 700 may be used herein in any suitable size, shape, or configuration. Combinations of different type of fins 700 also may be used herein. The fins 700 provide an increase in surface area and hence an increase in heat transfer between the phase change material 120 and the air in the cabinet 104. Other components and other configurations also may be used herein.

Although specific embodiments of the disclosure have been described, numerous other modifications and alternative embodiments are within the scope of the disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A phase change material panel for cooling a cabinet of a merchandiser, the panel comprising:
a refrigerant tube;
an outer jacket surrounding the refrigerant tube; and
a phase change material positioned between the refrigerant tube and the outer jacket and in contact with the refrigerant tube, wherein the phase change material panel is removable from the cabinet of the merchandiser.

2. The panel of claim 1, further comprising a flow of cooling fluid within the refrigerant tube.

3. The panel of claim 2, wherein the flow of cooling fluid freezes the phase change material.

4. The panel of claim 3, wherein the phase change material removes heat from the cabinet of the merchandiser by drawings heat from the air within the cabinet by melting.

5. The panel of claim 1, wherein the refrigerant tube comprises an inlet and an outlet.

6. The panel of claim 1, further comprising a plurality of compartments.

7. The panel of claim 1, wherein the refrigerant tube comprises a plurality of bends.

8. The panel of claim 1, wherein the phase change material comprises a wax.

9. A system for cooling a cabinet in a merchandiser, the system comprising:
a phase change material panel comprising
a refrigerant tube having an inlet and an outlet,
an outer jacket surrounding the refrigerant tube, and
a phase change material positioned between the refrigerant tube and the outer jacket and in contact with the refrigerant tube; and
a charging unit attachable to the inlet and the outlet of the phase change material panel.

10. The system of claim 9, further comprising a flow of cooling fluid within the refrigerant tube.

11. The system of claim 10, wherein the flow of cooling fluid flows from the charging unit, into the inlet of the refrigerant tube, and out of the outlet of the refrigerant tube back to the charging unit.

12. The system of claim 11, wherein the flow of cooling fluid freezes the phase change material.

13. The system of claim 12, wherein the phase change material removes heat from the cabinet of the merchandiser by drawings heat from the air within the cabinet by melting.

14. The system of claim 9, wherein the phase change material panel is removable from the cabinet of the merchandiser.

15. The system of claim 9, wherein the refrigerant tube comprises a plurality of bends.

16. The system of claim 9, wherein the phase change material comprises a wax.

17. A method for cooling a cabinet in a merchandiser, the method comprising:
attaching a charging unit to a phase change material panel;
flowing a cooling fluid through a refrigerant tube within an outer jacket of the phase change material panel;
freezing a phase change material positioned between the refrigerant tube and the outer jacket and in contact with the refrigerant tube; and
placing the phase change material panel within the cabinet of the merchandiser.

18. The method of claim 17, further comprising flowing the flow of cooling fluid from the charging unit, into an inlet of the refrigerant tube, and out of an outlet of the refrigerant tube back to the charging unit.

19. The method of claim 17, further comprising removing heat from the cabinet of the merchandiser by drawings heat from the air within the cabinet as the phase change material melts.

20. The method of claim 17, further comprising removing the phase change material panel from the cabinet of the merchandiser.

21. The method of claim 20, further comprising
recharging the phase change material panel and placing it back into the cabinet of the merchandiser; or
replacing the phase change material panel with a different phase change material panel that has been charged.
